(19) United States
(12) Patent Application Publication
(10) Pub. No.: US 2002/0079854 A1
(43) Pub. Date: Jun. 27, 2002

(54) Automatic gain adjustment for voice call motor back EMF monitor

(76) Inventors: Yasushi Kitamura, Tokyo (JP); Masaki Yamashita, Niiza-shi (JP); Jonathan Knight, Tokyo (JP)

Correspondence Address: W. Daniel Swayze, Jr., Texas Instruments Incorporated, MS 3999, P.O. Box 655474, Dallas, TX, 75265, US

(21) Appl. No.: 09/992,421

(22) Filed: Nov. 21, 2001

Related U.S. Application Data
(60) Provisional application No. 60/253,831, filed on Nov. 29, 2000.

(51) Int. Cl. H02P 1/00; H02P 3/00; G05B 5/00; H02P 7/00; H02H 7/08

(52) U.S. Cl. 318/459

(57) ABSTRACT

A method to trim a monitor circuit for a voice coil motor including the steps of transmitting a test current through a voice coil motor, determining if a linear response is generated by the monitoring circuit, trimming the monitoring circuit if a non-linear response is received; repeating said transmitting step, said delivery step and said trimming step until said trim is achieved.

### FIELD OF THE INVENTION

The present invention relates to control of motors and more particularly to a method and apparatus for accurately controlling the velocity of an actuary or motor member for monitoring the back electromagnetic force (EMF) of an actuator coil.

### BACKGROUND OF THE INVENTION

Conventional actuators, which are sometimes referred to as motors, have a movable supported member and a coil. When the current is passed through the coil, a motive force is exerted on the member. A control circuit is coupled to the coil in order to controllably supply current to the coil. One example of such arrangement is found in a hard disk drive, where the movable member of the actuator supports a read write head adjacent to a rotating main disk for approximate radial movement of the head relative to the disk. There are situations in which is desirable to move the member from one end of its path of travel at a predetermined velocity which is less than the maximum velocity.

When a current is applied to the coil of the actuator, the member is subjected to a force tending to accelerate the member at a rate defined by the magnitude of the current and at a direction defined by the polarity of the current. Consequently, in order to accelerate or decelerate the member until it is moving at the desired velocity and in the desired direction. It is important to note the actual direction and velocity of the member, In this regard, it is known that the back EMF voltage on the coil of the actuator is representative of the velocity direction of movement of the member. When a current is supplied to the coil of the actuator, the member is subjected to a force tending to accelerate the member at a rate defined by a magnitude of the current, and at direction defined by the polarity of the current. Consequently, in order to accelerate or decelerate the member till it is moving at the desired velocity and in the desired direction, it is important to know the actual direction and the velocity of the member. In this regard, it is known that the back EMF voltage of the coil of the actuator is representative of the velocity and direction of movement of the member. Specifically, the following relationship applies to actuators:

V_{M}=I_{M}×R_{M}+K_{E}ω

Where the V_{M}is the voltage across the actuator (motor), in the current through the actuator R_{M}is internal resistance of the actuator, and K_{E}=torque constant of the actuator and ω=velocity of the actuator. The term, K_{E}ωrepresents the back-EMF of the actuator coil.

It is desirable to have a control circuit for an actuator that actually monitors the back-EMF of the actuator coil and effectively controls the movement of the actuator member under widely varying load conditions.

Typically, the back-EMF monitor circuits include a first step amplifier to measure the voltage across the voice coil motor by sense resistor. However, in order to output a signal which linearly reflects the back-EMF of the gain of the amplifier the gain of this first stage amplifier must be accurately adjusted. The gain typically equals G=R₂/R_{z}I which equals the ratio of the VCM coil resistance with respect to the resistance in parallel with the first stage amplifier. It is undesirable if the ratio of R₂ to R₁ does not equal the ratio of the resistance of the VCM to the resistance of the sensory resistor.

Under the conditions of the ratio of the resistance of R₂/R₁ is equal to the resistance of the VCM and the resistance of the sensor, there is a current component that varies linearly with the current through the VCM. The circuit to monitor the back EMF voltage should be independent of the current that actually goes through the VCM. Typically, the resistance of the VCM current cannot be manufactured with sufficient accuracy and usually possesses a significant temperature coefficient. The resistor R₁ is usually chosen to have a high degree of accuracy while the resistor R₂ is chosen to match the temperature coefficient of R_{VCM}.

### SUMMARY OF THE INVENTION

The present invention provides an adjustable resistance R₂ to which is automatically adjusted to maintain the proper R₂÷R₁ ratio which is achieved by passing a test current through the VCM, by measuring if the test current provides an ideal response from the voice coil motor, the adjusting the resistance R₂ by one increment and repeating the above step until R2 is chosen to be such that R₂/R₁=R_{VCM}/R_{SENS}. As a consequence, the gain of the amplifier is increased by increasing the resistance R₂ one bit at a time until the output of the amplifier is approximately linearly equal to the back EMF. Thus, the gain ratio R₂÷R₁ is properly adjusted to R_{VCM}. This operation is performed dynamically during the operation of the voice coil motor so that any variations in temperature which affects the voice coil motor will be compensated by appropriate changes of R₂.

### BRIEF DESCRIPTION OF THE DRAWINGS

FIG. 1 illustrates a back-EMF monitor circuit;

FIG. 2 illustrates a detailed chart of the present invention;

FIG. 3 illustrates a detailed chart description of R₂(resistor R10);

FIG. 4 illustrates a top view of a system of the present invention; and

FIG. 5 illustrates a side view of the system.

### DETAILED DESCRIPTION OF THE INVENTION

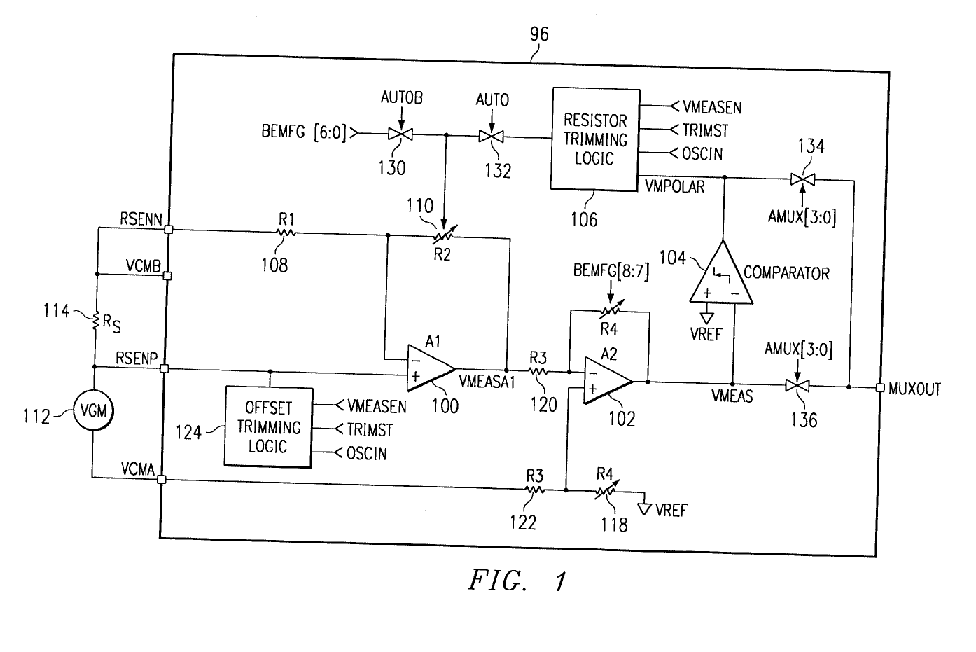

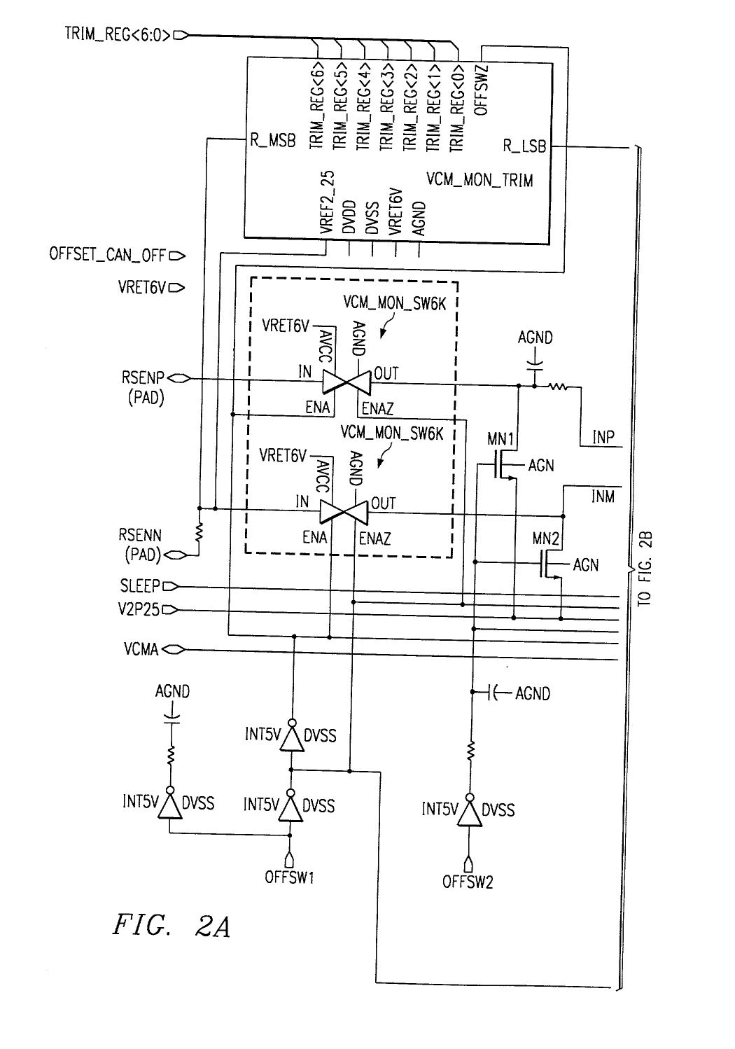

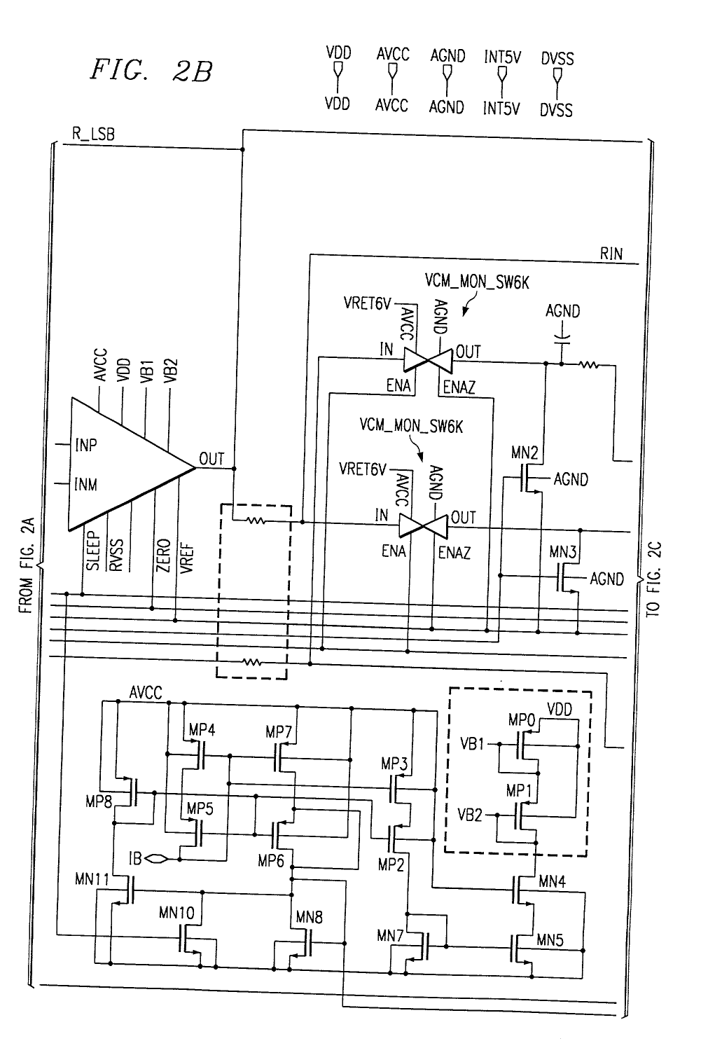

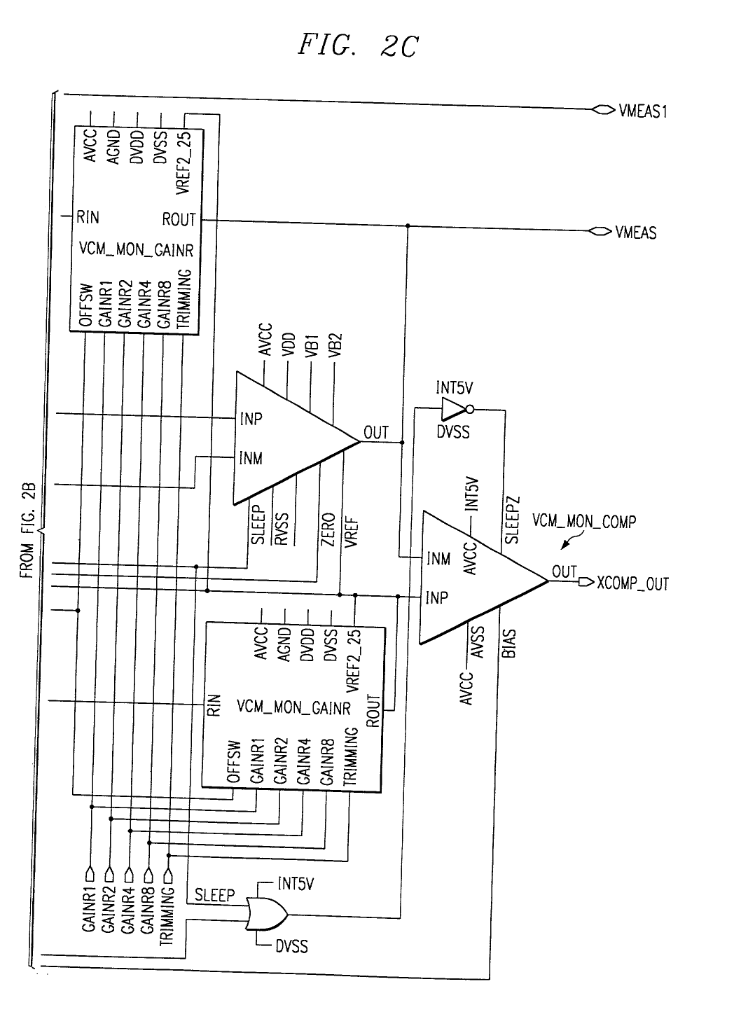

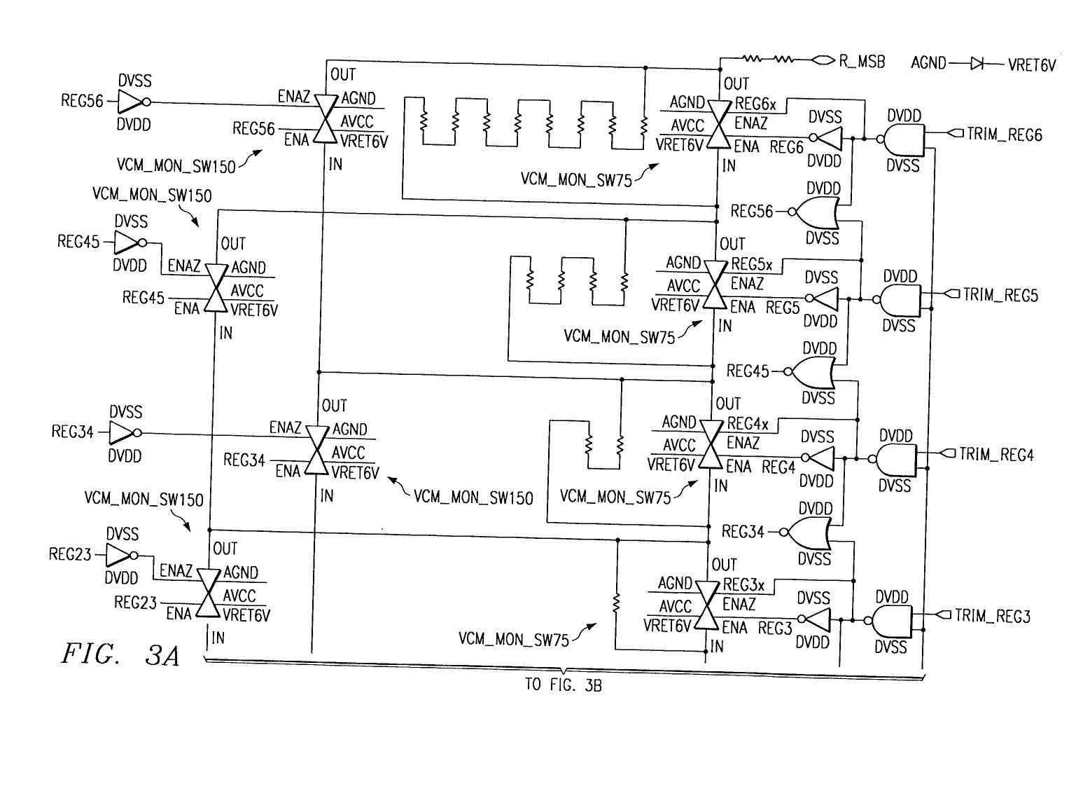

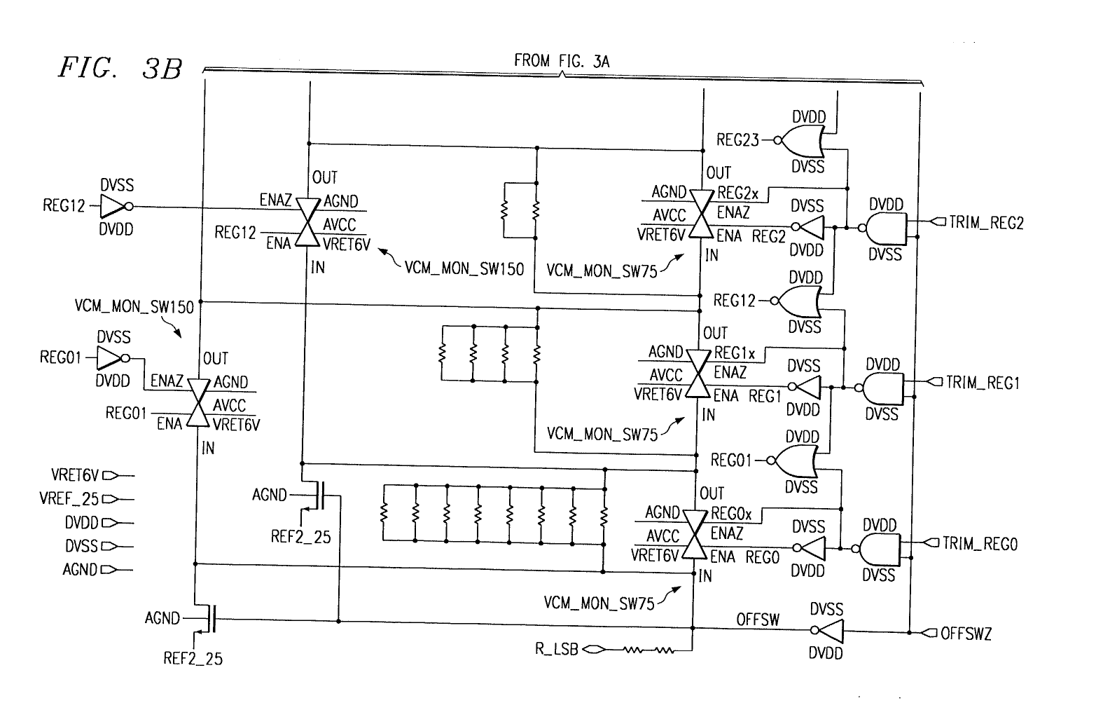

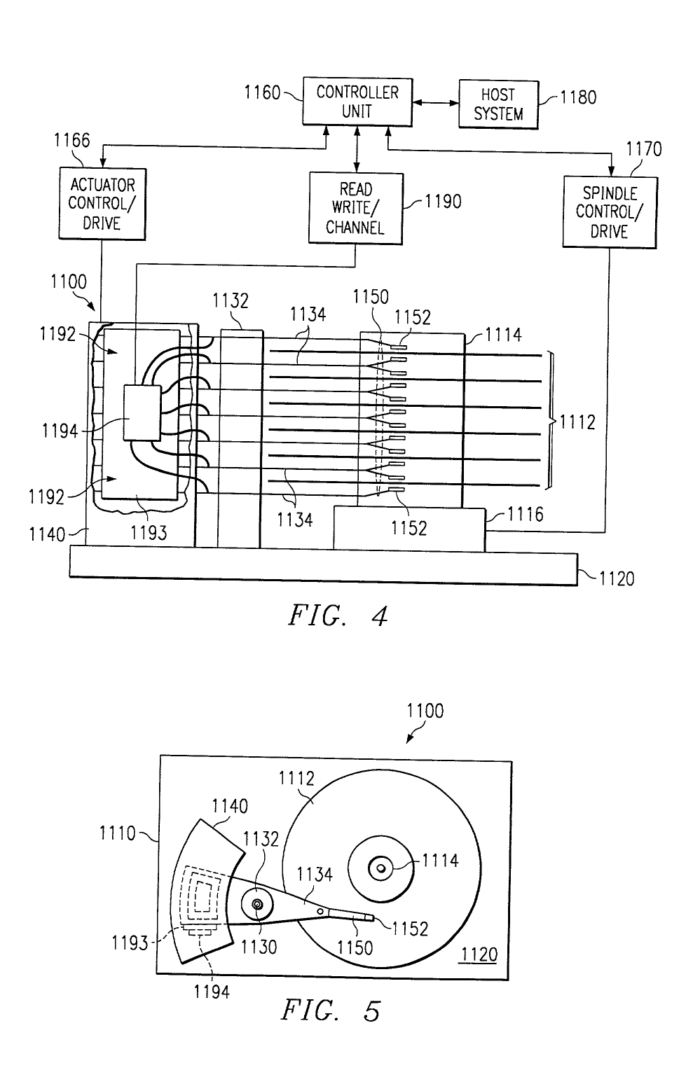

FIG. 1 illustrates a back-EMF monitor of the present invention. As illustrated, the VCM back-EMF monitor circuit is on chip 90. External to chip 90 is voice coil motor (VCM) 112 connected to in series to a sense resistor 114 which senses the current through the voice coil motor and consequently generates a voltage corresponding to the current. The integrated circuit 90 includes an amplifier 100 to amplify the output voltage of the VCM 112 and a resistor 108 is connected to the first side of sense resistor 114. The resistor 108 is used to determine the gain for amplifier 100. Connected to the other end of resistor 108 and connected to the negative input of amplifier 100 is resistor 110. The resistor 110 is a variable resistor to vary the gain of amplifier 100 such that the ratio of R₂ to R₁ is equal to R_{VCM} to R_{SENS}. The other end of resistor 110 is connected to the output of amplifier 100. The other input, namely in this embodiment, the plus input is connected to the other end of sense resistor 114 and connected to one end of the voice coil motor 1 14. Additionally, offset trimming logic 124 is connected to the plus input to amplifier 100. The offset trimming logic 124 performs ???????? (we need to expound here). The output of amplifier 100 is a voltage V_{MEASA1} which is a voltage which indicates the voltage across the voice coil motor 112. The resistor 110 is a variable resistance resistor and controlled by the resistor timing logic 106. The resistor trimming logic 106 outputs through transmission gauge 132 a signal to control resistor 110. One way that resistor 110 can be charged after receiving the signal is to increase by one unit the resistance of resistor 110. The voltage _{MEASA1} provides an indication of the current through the sense resistor 114.

Additionally, the VCM back-EMF monitor an integrated circuit 90 includes a second amplifier 102. The output of the amplifier 100 is connected to a resistor 120. The other side of resistor 120 is connected to the negative input of amplifier 102. Additionally, the other end of voice coil motor 112 is connected to resistor 122. The other end of resistor 122 is connected to the plus input of amplifier 102. Additionally, resistor 118 is connected to the plus input of amplifier 102 with the other end of resistor 118 being connected to voltage V-hd REF. Resistor 118 is to ? what is the function here? Additionally, the negative input of amplifier 102 is connected to resistor 116. Resistor 116 is a variable resistor to control the gain of amplifier 102. The other end of resistor 116 is connected to the output of amplifier 102. The output of amplifier 102 is a voltage V_{MEAS}. The voltage V_{MEAS} corresponds linearly to the back-EMF voltage of the VCM. The output of amplifier 102 is connected to comparator 104. The comparator 104 compares the voltage V_{MEAS} with the reference voltage V_{RCF}. The output of comparator 104 provides a voltage V_{MPOLAR} when the two voltages are equal or voltage V_{MEAS} is greater than the voltage V_{REF}. This indication when the two voltages are equal, namely, voltage V_{MPOLAR} is input to resistor trimming logic circuit 106 to indicate that the ideal or desired setting for resistor 110 has been reached. Transmission gate 132 controls the output of resistor trimming logic 106 to resistor 110. Additionally, transmission gate 130 allows the value of resistor 110 to be read outside of integrated circuit 90. The transmission gate 136 allows the voltage V_{MEAS} to be measured outside of integrated circuit 90. The transmission gate 134 allows ?????

In operation, a test current for example a current in the range of 25 to 100 miliamps are input through the voice coil motor 112. How? A sense voltage which results from the IR current resistor 114 is sensed across resistor 114, and this voltage is input to amplifier 100. The output from amplifier 100 is voltage V_{MEASA1} and this voltage is amplified by amplifier 102 and outputs an output voltage V_{MEAS}. This voltage corresponds linearly to the back-EMF. This voltage V_{MEAS} is compared with respect to the reference voltage V_{REF} at comparator 104. Assuming voltage V_{MEAS} is less than the reference voltage V_{REF} an output voltage from comparator 104 is input to resistor trimming logic 106 to provide a resistance value for R₂ resistance 110 to increase the resistance of resistor 110 incrementally by one. The resistance of resistor 110 is increased by one, and the process is repeated until the comparator 104 finds no difference in voltage between the output voltage of amplifier 102 namely V_{MEAS} and V_{REF} at which time the resistor trimming logic ceases incrementing the value of resistance for resistor 110. If the resistance value is desired to be read outside the integrated circuit 90, the transmission gate 130 is opened and the transmission gate 132 is closed. Furthermore, if the output of amplifier 102 desires to be measured the transmission gate 136 is open to allow the voltage to be read outside of integrated circuit 90.

1. A monitor circuit to monitor the back EMF voltage comprising:
a sense circuit to sense the back EMF voltage.
a measure circuit to determine if the back EMF voltage has a linear response in the monitor circuit.
a trim current to trim the nonlinear current to eliminate non-linear in the monitor circuit.

2. A monitor circuit as in claim 1 wherein said measure circuit measures an output voltage for an amplifier.

3. A monitor circuit as in claim 2 wherein said amplifier is biased by a variable resistor.

4. A monitor circuit as in claim 3 wherein said variable resistor is increased to achieve said linear response.

5. A method to trim a monitor circuit for a voice coil motor including the steps of:
transmitting a test current through a voice coil motor;
determining if a linear response is generated by said monitoring circuit;
trimming said monitoring current if a non-linear response is achieved; and
repeating said transmitting step, said determined step and said trimming step until said trim is achieved.

6. A monitor circuit as in claim 5 wherein said trim step is based on an output of an amplifier.

7. A monitor circuit as in claim 6 which said trimming step includes trimming a resistor.

8. A monitor circuit as in claim 7 which said trimming step is a resistance of said resistor is changed to trim said monitor circuit.
